(19) United States
(12) Patent Application Publication
(10) Pub. No.: US 2025/0261026 A1
(43) Pub. Date: Aug. 14, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Xin WANG, Beijing (CN)

(73) Assignee: FUJITSU LIMITED, Kawasaki-shi (JP)

(21) Appl. No.: 19/192,487

(22) Filed: Apr. 29, 2025

Related U.S. Application Data
(63) Continuation of application No. PCT/CN2022/130266, filed on Nov. 7, 2022.

(51) Int. Cl. H04W 24/10; H04W 72/044

(52) U.S. Cl. CPC H04W 24/10; H04W 72/046

(57) ABSTRACT

An information transceiving apparatus, applicable to a network device, includes: a transmitter configured to transmit reporting configuration information to a terminal equipment, the reporting configuration information comprising first information relating a first reference signal set, and/or second information relating a first receiving beam set, and/or third information relating a set of first transceiving beam pairs comprising first transmitting beams and first receiving beams; and a receiver configured to receive a measurement report transmitted by the terminal equipment, the measurement report comprising measurement results to which first reference signals in the first reference signal set correspond, and/or measurement results to which first receiving beams in the first receiving beam set correspond, and/or measurement results to which first transceiving beam pairs in the set of first transceiving beam pairs correspond.

### CROSS-REFERENCE TO RELATED APPLICATION

This application is a continuation application under 35 U.S.C. 111 (a) of International Patent Application PCT/CN2022/130266 filed on Nov. 7, 2022, and designated the U.S., the entire contents of which are incorporated herein by reference.

### TECHNICAL FIELD

This disclosure relates to the field of communication technologies.

### BACKGROUND

As low-frequency spectrum resources become scarce, millimeter wave bands are able to provide greater bandwidths and have become important frequency bands for 5G NR (New Radio) systems. As millimeter waves are relatively short in wavelengths and have propagation characteristics different from legacy low-frequency bands, such as higher propagation loss, and poor reflection and diffraction performances, etc., larger scales of antenna arrays are usually used to form shaped beams with greater gains, overcome propagation losses, and ensure system coverage. 5G NR standards have designed a series of solutions for beam management, including beam scanning, beam measurement, beam report, and beam indication, etc. However, when the number of transceiving beams is relatively large, the payload and latency of the system will be greatly increased.

With the development of artificial intelligence (AI) technologies, applying the AI technologies to physical layers of wireless communication to solve difficulties of legacy methods has become a current technological direction. For the beam management, using AI models to predict a spatially optimal beam pair according to results of measurement of a small number of beams may significantly reduce the payload and latency of the system.

It should be noted that the above description of background is merely provided for clear and complete explanation of this disclosure and for easy understanding by those skilled in the art. And it should not be understood that the above technical solution is known to those skilled in the art as it is described in the background of this disclosure.

### SUMMARY

Assuming that a transmitting end of a communication system has M beams and a receiving end thereof has N beams, in existing standards, it is needed to measure M*N beams. When values of M and N are relatively large, measuring M*N beams will result in a relatively large system payload and relatively long latency. Using models (such as AI models) to predict an optimal beam pair with results of measurement of a small number of beams may greatly reduce the system payload and latency caused by the beam measurement.

In a legacy beam measurement reporting process, a network device configures reference signal resources for beam measurement of a terminal equipment and carry them on different transmitting beams. The terminal equipment measures quality of reference signals on different transmitting beams, and reports up to K measurement results according to an implementation algorithm at the terminal equipment side (such as selecting one or more of them with the best quality to report).

It was found by the inventors that when an AI model is deployed at a network device side, a terminal equipment is unable to report measurement results according to implementation algorithms of its own in data collection for training the AI model or AI model inference or AI model performance monitoring. There is currently no solution to report measurement results for a terminal equipment when an AI model is used for beam (pair) prediction, or, in other words, there is currently no solution for a terminal equipment to determine to report measurement results of which beams.

In order to solve at least one of the above problems, embodiments of this disclosure provide an information transceiving method and apparatus.

According to one aspect of the embodiments of this disclosure, there is provided an information transceiving apparatus, applicable to a terminal equipment, the apparatus including:
a receiver configured to receive reporting configuration information transmitted by a network device, the reporting configuration information including the first information relating a first reference signal set, and/or second information relating a first receiving beam set, and/or third information relating a set of first transceiving beam pairs including first transmitting beams and first receiving beams; and
a transmitter configured to transmit a measurement report to the network device, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

According to another aspect of the embodiments of this disclosure, there is provided an information transceiving apparatus, applicable to a network device, the apparatus including:
a transmitter configured to transmit reporting configuration information to a terminal equipment, the reporting configuration information including first information relating a first reference signal set, and/or second information relating a first receiving beam set, and/or third information relating a set of first transceiving beam pairs including first transmitting beams and first receiving beams; and
a receiver configured to receive a measurement report transmitted by the terminal equipment, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

According to a further aspect of the embodiments of this disclosure, there is provided a communication system, including a terminal equipment and/or a network device, the terminal equipment including the information transceiving apparatus described in the one aspect, and the network device including the information transceiving apparatus described in the other aspect.

An advantage of the embodiments of this disclosure exists in that by configuring information on the first transmitting beam (corresponding to the first reference signal) or the first receiving beam or the first transceiving beam pair for the terminal equipment that needs to be reported by the terminal equipment, the terminal equipment reports the beam measurement results specified by the network device according to the configuration, thereby effectively enabling the AI model to operate in the inference stage, data collection stage for training, or model performance monitoring stage.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of a transmitting beam and a receiving beam in the communication system of the embodiments of this disclosure;

FIG. 3 is a schematic diagram of an information transceiving method of embodiments of this disclosure;

FIGS. 4-6 are schematic diagrams of a transceiving beam and an AI model of the embodiments of this disclosure;

FIGS. 7-9 are schematic diagram of a first receiving beam of the embodiments of this disclosure;

FIG. 10 is a schematic diagram of an information transceiving method of embodiments of this disclosure;

FIG. 11 is a schematic diagram of an information transceiving method of embodiments of this disclosure;

FIG. 12 is a schematic diagram of an information transceiving apparatus of embodiments of this disclosure;

FIG. 13 is a schematic diagram of an information transceiving apparatus of embodiments of this disclosure;

FIG. 14 is a schematic diagram of a network device of embodiments of this disclosure;

FIG. 15 is a schematic diagram of a terminal equipment of embodiments of this disclosure; and

FIG. 16 is a schematic diagram of an information transceiving method of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to in differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal equipment” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher layer signaling may be, for example, radio resource control (RRC) signaling; for example, it is referred to an RRC message, which includes an MIB, system information, and a dedicated RRC message; or, it is referred to an as an RRC information element (RRC IE). Higher layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

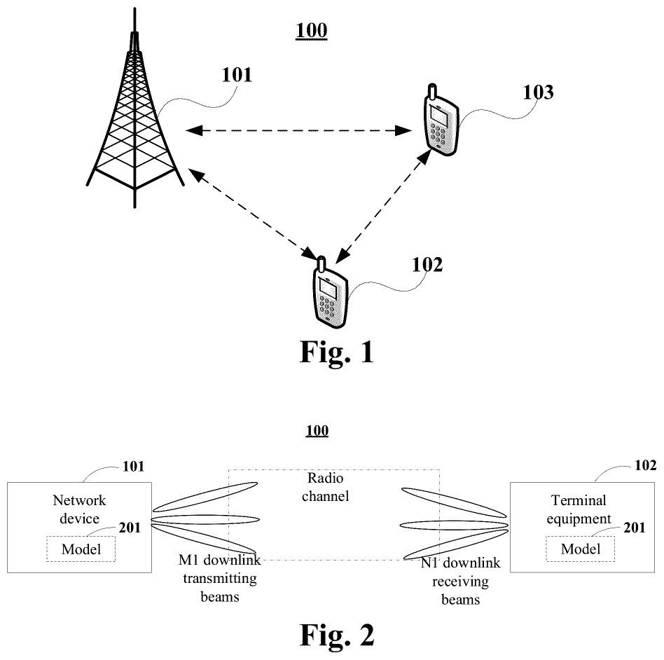

FIG. 1 is a schematic diagram of a communication system of embodiments of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

An AI model (or an ML model) includes but is not limited to an input layer (input), multiple convolutional layers, a concatenation layer (concat), a fully connected layer (FC), and a quantizer, etc., and processing results of the multiple convolutional layers are merged in the concatenation layer. Reference may be made to existing techniques for a specific structure of the AI model, which shall not be repeated herein any further.

FIG. 2 is a schematic diagram of a transmitting beam and a receiving beam in the communication system of the embodiments of this disclosure. As shown in FIG. 2, in the communication system 100, taking a downlink channel as an example, the network device 101 may have M1 downlink transmitting beams DL TX, and the terminal equipment 102 may have N1 downlink receiving beams DL RX.

In the embodiments of this disclosure, as shown in FIG. 2, a model 201 for predicting the optimal beam (pair) may be deployed in the network device 101 or the terminal equipment 102. The model 201 may predict optimal beam (pair) of M1*N1 beams according to measurement results of a part of beams. Wherein, the model 201 may be, for example, an AI model. The model 201 may be deployed in the network device 101 or the terminal equipment 102.

In addition, for an uplink channel, the network device 101 may have N2 uplink receiving beams (not shown in FIG. 2), and the terminal equipment 102 may have M2 uplink transmitting beams UL TX (not shown in FIG. 2).

Regarding the above problems, the embodiments of this disclosure provide an information transceiving method and apparatus, which shall be described below with reference to the accompanying drawings and embodiments.

### Embodiments of a First Aspect

The embodiments of this disclosure provide an information transceiving method, which shall be described from a network device side. An AI model is deployed at the network device side.

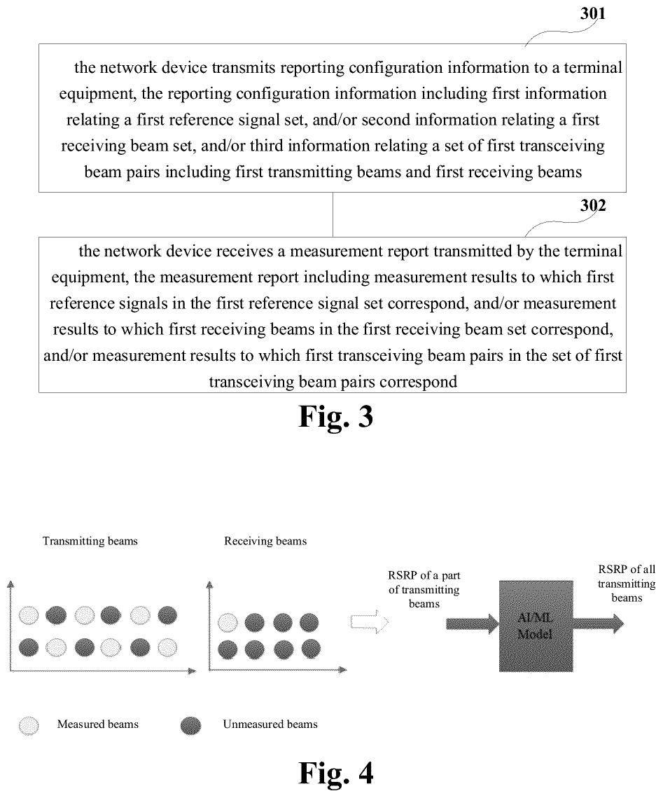

FIG. 3 is a schematic diagram of the information transceiving method of the embodiments of this disclosure. As shown in FIG. 3, the method includes:
301: the network device transmits reporting configuration information to a terminal equipment, the reporting configuration information including first information relating a first reference signal set, and/or second information relating a first receiving beam set, and/or third information relating a set of first transceiving beam pairs including first transmitting beams and first receiving beams; and
302: the network device receives a measurement report transmitted by the terminal equipment, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

It should be noted that FIG. 3 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

With the above embodiments, by configuring information on the first transmitting beam (corresponding to the first reference signal) or the first receiving beam or the first transceiving beam pair for the terminal equipment that needs to be reported by the terminal equipment, the terminal equipment reports the beam measurement results specified by the network device according to the configuration, thereby effectively enabling the AI model to operate in the inference stage, data collection stage for training, or model performance monitoring stage.

In some embodiments, an AI model for beam prediction is deployed in the network device. By applying the AI model, the AI model may be used to predict the optimal beam (pair) among the transmitting beams, or the receiving beams, or the beam pairs (a combination of a transmitting beam and a receiving beam is taken as a beam pair). The transmitting beams and the receiving beams are downlink transmitting beams and downlink receiving beams, and the above beams may be wide beams or narrow beams, and the embodiments of this disclosure are not limited thereto. The measurement results include an RSRP (reference signal receiving power) value or an SINR (signal to interference plus noise ratio) value.

In some embodiments, the network device may configure measurement resources for the downlink beams, and the measurement resources may be reference signals, such as CSI-RSs and/or SSBs. The network device transmits reference signals for beam measurement via one or more downlink transmitting beams, and the terminal equipment receives the reference signals for beam measurement via one or more downlink receiving beams, measures the measurement results of the downlink transmitting beams or downlink receiving beam or downlink transceiving beam pairs based on the reference signals. The terminal equipment reports the measurement results, and the network device performs AI model data collection, model inference or performance monitoring of the model according to the received measurement results.

For example, an AI model is used to predict the optimal beam among the transmitting beams, the receiving beam of the terminal equipment is fixed to be one, the network device may use a part of the downlink transmitting beams only, and the AI model predicts the optimal beam among all the downlink transmitting beams according to measurement results of the part of the downlink transmitting beams. Input parameters of the AI model are the measurement results of the part of the downlink transmitting beams, and a physical quantity of output thereof is the predicted results of all the downlink transmitting beams. FIG. 4 is a schematic diagram of the transmitting beams, the receiving beams and the AI model in the embodiments of this disclosure. As shown in FIG. 4, for example, there are 12 downlink transmitting beams and 8 downlink receiving beams, but the receiving beam is fixed to be one. Through configuration, the terminal equipment only reports measurement results of 6 downlink transmitting beams therein. At this point, a dimension of the input parameters of the AI model is 6, a physical quantity thereof is measured RSRP or an SINR, and a dimension of the output parameters is 12, a physical quantity thereof is also the predicted RSRP or SINR.

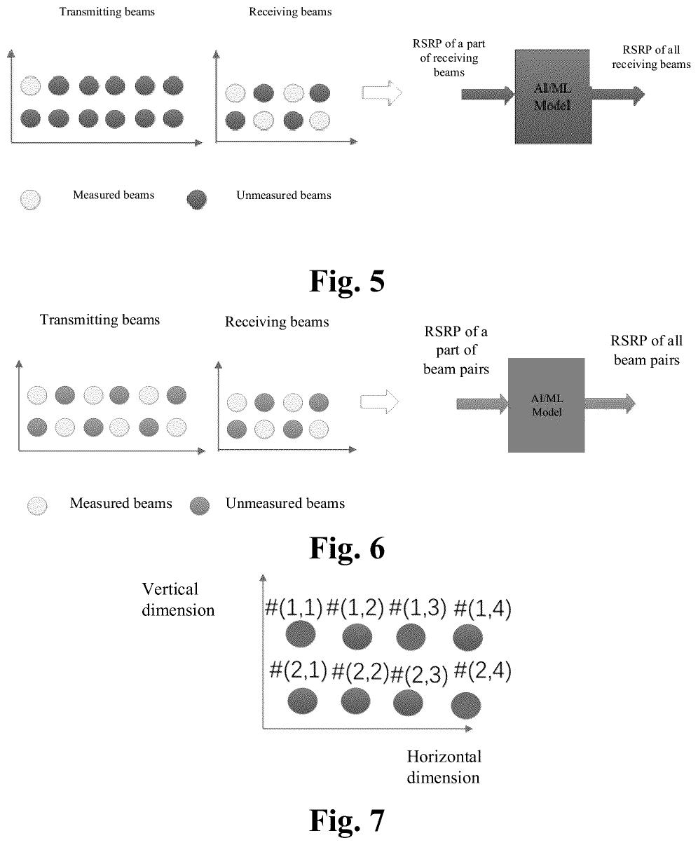

For example, the AI model is used to predict the optimal beam among the receiving beam, the transmitting beam is fixed to be 1, the terminal equipment may use a part of the downlink receiving beams only, and the AI model predicts the optimal beam among all the downlink receiving beams according to measurement results of the part of the downlink receiving beams. The input parameters of the AI model are the measurement results of the part of the downlink receiving beams, and a physical quantity of the output thereof is the predicted results of all the downlink receiving beams. FIG. 5 is a schematic diagram of the transmitting beam, receiving beams and AI model in the embodiments of this disclosure. As shown in FIG. 5, for example, there are 12 downlink transmitting beams and 8 downlink receiving beams, but the transmitting beam is fixed to be 1. Through configuration, the terminal equipment only reports measurement results of four downlink receiving beams therein. At this point, a dimension of the input parameters of the AI model is 4, a physical quantity thereof is measured RSRP or an SINR, and a dimension of the output parameters is 8, a physical quantity thereof is the predicted RSRP or SINR.

In the above embodiments, how to select fixed receiving beams or transmitting beams is not limited.

For example, the AI model is used to predict the optimal beam pair of the transceiving beam pairs, and the AI model predicts the optimal beam pair among all the beam pairs according to measurement results of a part of the transceiving beam pairs. The input parameters of the AI model are measurement results of the part of the transceiving beam pairs, and a physical quantity of the output thereof is predicted results of all the transceiving beam pairs. FIG. 6 is a schematic diagram of the transmitting beams, receiving beams and AI model in the embodiments of this disclosure. As shown in FIG. 6, for example, there are 12 downlink transmitting beams and 8 downlink receiving beams. Through configuration, the terminal equipment only reports measurement results of 6 downlink receiving beams and 4 downlink receiving beams therein (there are total 24 transceiving beam pairs). At this point, a dimension of the input parameters of the AI model is 24, a physical quantity thereof is measured RSRP or an SINR, and a dimension of the output parameters is 96, a physical quantity thereof is the predicted RSRP or SINR.

In some embodiments, the network device may transmit measurement resource configuration information to the terminal equipment, the measurement resource configuration information including measurement resources (reference signals), the measurement resources (reference signals) being reference signals, such as CSI-RSs and/or SSBs, etc. For example, the configured measurement resources are a resource set list (reference signal sets), each resource set consisting of one or more measurement resources (reference signals). In other words, the network device may configure multiple reference signals for beam measurement for the terminal equipment. The measurement resource configuration information includes a reference signal set identifier (measurement resource set identifier) and an identifier/identifiers of one or more measurement resources (reference signals) constituting the reference signal set (measurement resource set). For example, the measurement resource configuration information may be expressed by an information element NZP-CSI-RS-ResourceSet or CSI-SSB-ResourceSet; however, this is illustrative only, and the embodiments of this disclosure are not limited thereto.

In some embodiments, the network device may further transmit the reporting configuration information, the reporting configuration information being used to configure parameters needed for reporting from the terminal equipment. For example, the reporting configuration information includes the first information relating the first reference signal set, and/or the second information relating the first receiving beam set, and/or the third information relating the set of first transceiving beam pairs including first transmitting beams and first receiving beams. Optionally, the reporting configuration information may further include a report quantity, and a report configuration type, etc. For example, when beam management is needed, the report quantity is a combination of the following parameters: CRI-RSRP/SINR (CSI-RS-based beam management) or SSBRI-RSRP/SINR (SSB-based beam management).

### (I) First Information

In some embodiments, the first reference signal in the first reference signal set is one or more reference signals in the reference signal set, or the first reference signal set includes all or a part of reference signals in the above reference signal set. The first reference signal corresponds to a first transmitting beam in the downlink transmitting beams, and is transmitted on the corresponding first transmitting beam, and the network device side learns correspondence between the first reference signal and the first transmitting beam. “A first transmitting beam”, “a first reference signal” and “a first downlink transmitting beam” are interchangeable.

In some embodiments, the first information relating the first reference signal set includes an index of the first reference signal, for example, when the first reference signal is a CSI-RS, the index of the first reference signal may be a CRI, and when the first reference signal is an SSB, the index of the first reference signal may be an SSB RI. That is, the first information relating the first reference signal set may include an index of one first reference signal or a list of indices of multiple first reference signals.

In some embodiments, as a resource set list (reference signal set) is configured in the measurement resource configuration information, when the network device configures that the terminal equipment needs to report measurement results to which all reference signals in the reference signal set correspond, the first information may also be indication information of the first reference signal. The indication information may be a first reference signal set identifier, for example, the first information of the first reference signal set is expressed by using an existing information element resourcesForChannelMeasurement, that is, CSI-ResourceConfigId is the first reference signal set identifier. According to CSI-ResourceConfigId and the ID of the reference signal set in the measurement resource configuration information (nzp-CSI-RS-ResourceSetId or csi-SSB-ResourceSetId), it may be determined that the first reference signal set is a corresponding reference signal set in the above measurement configuration information. In other words, when there is no other types of first information described later in the reporting configuration information and resourcesForChannelMeasurement is included, it indicates that the first reference signal set is equivalent to the above reference signal set.

For example, the reporting configuration information may be expressed by using an existing RRC signaling information element CSI-ReportConfig; however, this is illustrative only, and the embodiments of this disclosure are not limited thereto. CSI-ReportConfig may be expressed as follows by using an ASN.1 data format:

- ASN1START
-- TAG-CSI-REPORTCONFIG-START

| | |
|---|---|
| CSI-ReportConfig ::= | SEQUENCE { |

| | |
|---|---|
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
(1..maxNrofUL-Allocations)) OF INTEGER(0..32)
      }
  },
  ......
-- TAG-CSI-REPORTCONFIG-STOP
-- ASN1STOP
```

Wherein reportConfigId denotes an identifier to which the reporting configuration corresponds, and the reused information element resourcesForChannelMeasurement denotes the first information of the first reference signal set. That is, CSI-ResourceConfigId is the identifier of the first reference signal set, and according to CSI-ResourceConfigId and the ID of the reference signal set in the measurement resource configuration information (nzp-CSI-RS-ResourceSetId or csi-SSB-ResourceSetId), it may be determined that the first reference signal set is the reference signal set in the above measurement configuration information. reportConfigType is a reporting configuration type, including periodic, semi-persistent semiPersistentOnPUCCH/semiPersistentOnPUSCH, and aperiodic.

In some embodiments, as a resource set list (reference signal set) is configured in the measurement resource configuration information, the first information may also be indication information of the first reference signal. The indication information may indicate a starting position which can be an index in the reference signal set and interval information which can be the index interval in the reference signal set, or a bitmap of the first reference signal set corresponding to the reference signal set. Wherein, the reporting configuration information may further include a reference signal set identifier, which is used to indicate an ID (nzp-CSI-RS-ResourceSetId or csi-SSB-ResourceSetId) of the reference signal set in the measurement resource configuration information to which the first information in the reporting configuration information corresponds.

For example, the indication information indicates the starting position and the interval information. In this example, the terminal equipment determines a corresponding reference signal set according to the reference signal set identifier, and then determines the first reference signals in the first reference signal set according to the starting position and the interval information. For example, the reference signal set indicated by the reference signal set identifier contains 64 reference signals (corresponding to different downlink transmitting beams). Assuming that the starting position is 0 and the interval information is 8, the first reference signals included in the first reference signal set are 0th, 8th, 16th, 24th, 32th, 40th, 48th, 56th and 64th reference signals.

For example, the reporting configuration information may be carried by newly-added RRC signaling CSI-Report-Subset-Config, and may be expressed as follows by using an ASN.1 data format:

- ASN1START
-- TAG-CSI-REPORT-SUBSET-CONFIG-START

| CSI-Report-Subset-Config::= | SEQUENCE { | |
|---|---|---|
| subsetreportConfigId | | CSI- |
| | | ReportSubsetConfigId |

| | |
|---|---|
| reportConfigId | CSI-ReportConfigId, |
| csi-reportsubset | CHOICE{ --OPTIONAL |

```
      csi-report-subset-nzp-CSI-RS SEQUENCE{
              nzp-CSI-RS-ResourceSetId NZP-CSI-RS-
              ResourceSetId
```

| | |
|---|---|
| csi-report-subset | SEQUENCE { |

```
          startIndexofCSI-RS-Resourceset INTEGER(0..63)
          intervalofCSI-RS-Resoruceset INTEGER(1..62)
              }
      }
      csi-report-subset-CSI-SSB SEQUENCE{
              csi-SSB-ResourceSetId CSI-SSB-ResourceSetId
```

| | |
|---|---|
| csi-report-subset | SEQUENCE { |

```
          startIndexofCSI-RS-Resourceset INTEGER(0..63)
          intervalofCSI-RS-Resoruceset INTEGER(1..62)
              }
      }
    }
}
-- TAG- CSI-REPORT-SUBSET-CONFIG -STOP
-- ASN1STOP
```

Wherein, reporting configuration information RRC signaling CSI-Report-Subset-Config is newly added, and includes a reference signal set identifier, which is used to indicate an ID of the reference signal set in the measurement resource configuration signaling (nzp-CSI-RS-ResourceSetId or csi-SSB-ResourceSetId), and the starting position and the interval information (startIndexofCSI-RS-Resourceset+intervalofCSI-RS-Resoruceset), a data type thereof is an integer data type, and a value range thereof is determined by the number of reference signals in the reference signal set (with a maximum value of maxNrofNZP-CSI-RS-ResourcesPerSet or maxNrofCSI-SSB-ResourcePerSet). Names, data types and value ranges of the above fields are illustrative only, and are not limited in the embodiments of this disclosure.

The reporting configuration information may also be a newly-added field/information element csi-report-subset, which is included in the existing RRC signaling information element CSI-ReportConfig. csi-report-subset may include the above startIndexofCSI-RS-Resourceset+intervalofCSI-RS-Resoruceset, implementation of which being similar to those described above, which shall not be repeated herein any further.

For example, the indication information indicates a bitmap of the first reference signal set corresponding to the reference signal set. When a bit value is 1, it indicates that the corresponding reference signal is the first reference signal, that is, the measurement report needs to include measurement results of downlink transmitting beams corresponding to the reference signal to which the bit corresponds, and when the bit value is 0, it indicates that the corresponding reference signal is not the first reference signal, that is, it is indicated the measurement report does not include the measurement results of downlink transmitting beams corresponding to the reference signal to which the bit corresponds. For example, the reference signal set indicated by the reference signal set identifier contains 64 reference signals (corresponding to different downlink transmitting beams respectively). Assuming that the bitmap has total 64 bits, which are 1000000100000001 . . . , the first reference signals included in the first reference signal set are 0th, 8th, 16th, . . . reference signals.

For example, the reporting configuration information may be newly-added RRC signaling CSI-Report-Subset-Config, including the bitmap of the first reference signal set corresponding to the reference signal set. Following is an example of CSI-Report-Subset-Config expressed by using an ASN.1 data format:

- ASN1START
-- TAG-CSI-REPORT-SUBSET-CONFIG-START

| | |
|---|---|
| CSI-Report-Subset-Config::= | SEQUENCE { |

| | |
|---|---|
| subsetreportConfigId | CSI-ReportSubsetConfigId |

| | |
|---|---|
| reportConfigId | CSI-ReportConfigId, --OPTIONAL |
| csi-reportsubset | CHOICE{ |

```
      csi-report-subset-nzp-CSI-RS SEQUENCE{
            nzp-CSI-RS-ResourceSetId NZP-CSI-RS-ResourceSetId
```

| | |
|---|---|
| csi-report-subset | BIT STRING |

```
(size(maxNrofNZP-CSI-RS-ResourcesPerSet))
      }
      csi-report-subset-CSI-SSB SEQUENCE{
            csi-SSB-ResourceSetId CSI-SSB-ResourceSetId
```

| | |
|---|---|
| csi-report-subset | BIT STRING |

```
(size(maxNrofCSI-SSB-ResourcePerSet))
      }
    }
}
-- TAG- CSI-REPORT-SUBSET-CONFIG -STOP
-- ASN1STOP
```

Wherein, RRC signaling CSI-Report-Subset-Config is newly added, and includes a reference signal set identifier, which is used to indicate an ID (nzp-CSI-RS-ResourceSetId or csi-SSB-ResourceSetId) of the reference signal set in the measurement resource configuration signaling to which resourcesForChannelMeasurement corresponds, and a bitmap (csi-report-subset) of the first reference signal set corresponding to the reference signal set, a data type thereof is a bit sequence, and a length of the bitmap is determined by the number maxNrofNZP-CSI-RS-ResourcesPerSet or maxNrofCSI-SSB-ResourcePerSet of reference signals in the reference signal set. When a bit value is 1, it indicates that measurement report needs to include measurement results of downlink transmitting beams corresponding to the reference signal to which the bit corresponds, and when the bit value is 0, it indicates that the measurement report does not include the measurement results of downlink transmitting beams corresponding to the reference signal to which the bit corresponds. Names, data types and value ranges of the above fields are illustrative only, and are not limited in the embodiments of this disclosure.

The reporting configuration information may also be a newly-added field/information element csi-report-subset, which is included in the existing RRC signaling information element CSI-ReportConfig. csi-report-subset may include the above bitmap, and implementation of which is similar to that described above, which shall not be repeated herein any further.

In the above embodiments, when the newly-added signaling or newly-added field or newly-added information element is present, it indicates that the first reference signals to which the measurement results to be reported correspond are a part of reference signals in the reference signal set, and when the newly-added signaling or newly-added field or newly-added information element is not present, it indicates that the first reference signals to which the measurement results to be reported correspond are all reference signals in the reference signal set. However, this is illustrative only, and the embodiments of this disclosure are not limited thereto.

### (II) Second Information

In some embodiments, the first receiving beam set may be all downlink receiving beams or a part of downlink receiving beams in the downlink receiving beams, and the second information relating the first receiving beam set includes first receiving beam identification information or first receiving beam angle information. “A first receiving beam and “a first downlink receiving beam” may be interchangeable.

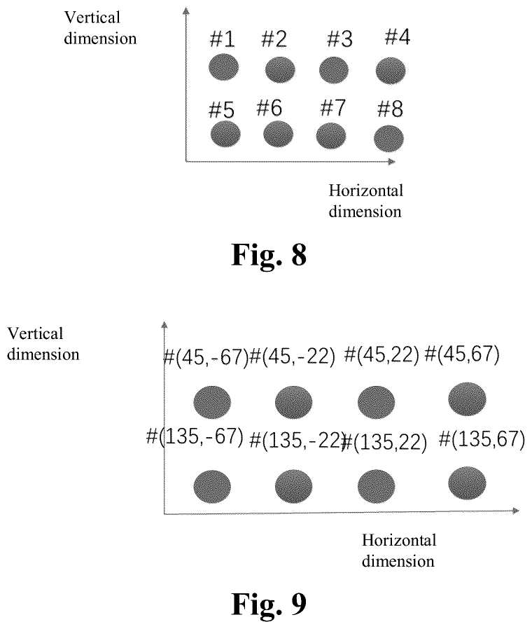

For example, the first receiving beam identification information includes a first identifier which is the beam index in horizonal dimension and a second identifier which is beam index in vertical dimension, or includes a third identifier of a beam index. Wherein, if the first receiving beams are 3D beamforming, that is, the beams may contain two dimensions, a horizontal dimension and a vertical dimension, they may be sequentially numbered in the horizontal dimension and vertical dimension respectively (taking 8 first receiving beams as an example, as shown in FIG. 7). Hence, the first receiving beam identification information includes the first identifier which is the beam index in horizonal dimension and the v second identifier which is the beam index in vertical dimension. Or, they may be uniformly numbered in sequence as per the two dimensions (taking 8 first receiving beams as an example, as shown in FIG. 8). Hence, the first receiving beam identification information includes the third identifier of the beam index. It should be noted that in FIG. 7 and FIG. 8, index is performed in an order of the horizontal dimension first and then the vertical dimension by taking 8 first receiving beams as an example. However, the embodiments of this disclosure are not limited thereto, and the index may also be performed in an order of the vertical dimension first and then the horizontal dimension, or the number of the first receiving beams may be other number, which shall not be enumerated herein any further. The above first identifier, second identifier and third identifier may be expressed by binary encoding of predetermined bits. That is, the second information includes one first receiving beam identification information or multiple first receiving beam identification information.

For example, the first receiving beam angle information includes horizontal beam angle information and vertical beam angle information. Wherein, if the first receiving beams are 3D beamforming, that is, the beams may contain two dimensions, horizontal dimension and vertical dimension, a horizontal dimension angle and a vertical dimension angle of the first receiving beams in space may be used to uniquely indicate a beam. By taking 8 first receiving beams as an example, FIG. 9 is an illustration of the first receiving beam angle information. As shown in FIG. 9, assuming that there are 2 angles in the vertical dimension (e.g. 45 degrees, 135 degrees) and 4 angles in the horizontal dimension (e.g. −67 degrees, −22 degrees, 22 degrees, 67 degrees), the first receiving beam angle information includes the horizontal dimension beam angle information and vertical dimension beam angle information. It should be noted that in FIG. 9, 8 first receiving beam angle information, 2 angles in the vertical dimension and 4 angles in the horizontal dimension are taken as examples. However, the embodiments of this disclosure are not limited thereto, which shall not be exemplified one by one herein any further. The above horizontal dimension beam angle information and vertical dimension beam angle information may be expressed by binary encoding of predetermined bits. That is, the second information includes one first receiving beam angle information or multiple first receiving beam angle information.

Optionally, the second information of the first receiving beam set may also be uplink transmitting beam indication information corresponding to the first receiving beams, and with reciprocity in a radio channel space, a direction of the uplink transmitting beams is basically in consistence with that of the downlink receiving beams. Therefore, the uplink transmitting beams corresponding to the first receiving beams may be used to implicitly indicate the first receiving beams. The uplink transmitting beam indication information includes an SRS resource indicator (SRI) or a random access preamble index (PRACH preamble index), i.e. the first receiving beams may be implicitly indicated by the SRI or PRACH preamble index. That is, the second information includes one uplink transmitting beam indication information (an SRI or PRACH preamble index) or multiple uplink transmitting beam indication information (SRIs or PRACH preamble indices).

In some embodiments, the second information of the first receiving beam set may be configured via RRC signaling. Information elements of the second information of the first receiving beam set may be added in the signaling CSI-ReportConfig to indicate the receiving beams to which the measurement results that the terminal equipment needs to report correspond.

CSI-ReportConfig may be expressed as follows by using an ASN.1 data format:

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| rx-beam-set | SEQUENCE (SIZE |

(1..maxNrofRxBeam)) OF RX-BEAM-Index OPTIONAL,
...
-- TAG-CSI-REPORTCONFIG-STOP
-- ASN1STOP

In the above embodiments, an information element of rx-beam-set is added to CSI-ReportConfig to indicate the second information of the first receiving beam set, wherein maxNrofRxBeam is a maximum number of first receiving beams in the set. And an Rx-beam-index sequence is used to describe the first receiving beams contained in the first receiving beam set, wherein Rx-beam-index may be the first receiving beam identification information or the first receiving beam angle information or the SRS resource indicator (SRI) or the random access preamble index (PRACH preamble index).

The above adding the information elements, parameter names and data types is illustrative only, and is not limited in this disclosure.

In the above embodiments, when the information element of the second information of the first receiving beam set (e.g. rx-beam-set) is present, it indicates that the terminal equipment needs to report measurement results of corresponding first receiving beams or first transceiving beam pairs.

### (III) Third Information

In some embodiments, the first transceiving beam pair set may be all or a part of downlink transceiving beam pairs in the downlink transceiving beam pairs, each downlink transceiving beam pair (first transceiving beam pair) is a combination of one first transmitting beam and one first receiving beam. For example, the third information of the first transceiving beam pair set includes the first information and the second information. “A first transceiving beam pair” and “a first downlink transceiving beam pair” interchangeable. Reference may be made to (I) and (II) above for the index of the first reference signal, the first information or the second information. For example, an information element rx-beam-set and an information element csi-report-subset are added into the existing RRC signaling CSI-ReportConfig and taken as the third information, or an information element rx-beam-set is added into the existing RRC signaling CSI-ReportConfig and combined with an existing parameter resourcesForChannelMeasurement to be taken as the third information, which shall not be enumerated herein any further.

In some embodiments, the reporting configuration information may be carried by RRC and/or an MAC CE and/or DCI, and an information element may be newly added into existing RRC or MAC CE or DCI to carry the reporting configuration information, or the reporting configuration information may be carried by an existing information element in existing RRC or MAC CE or DCI, or new RRC or MAC CE or DCI may be designed to carry the reporting configuration information; however, the embodiments of this disclosure are not limited thereto. For example, the reporting configuration information may be included as a new information element in the existing RRC signaling, which may be new RRC signaling, or newly-added MAC CE signaling, or a part of the reporting configuration information may be included as a newly-added information element in the existing RRC signaling, and another part thereof is newly-added RRC signaling or newly-added MAC CE signaling, or a part thereof is newly-added RRC signaling, and another part is newly-added MAC CE signaling, which shall not be enumerated herein any further.

In the above embodiments, when the reporting configuration information is present, it indicates that the reported measurement results are applied in a scenario where the AI model is deployed, the measurement results being used for beam management based on the AI model (such as data collection, or inference, or monitoring, of the AI model), and when the reporting configuration information is not present, the reported measurement results are applied in a scenario where no AI model is deployed, the measurement results being used for legacy beam management.

The above description is given by taking deploying one AI model at the network device side as an example. When multiple AI models having identical functions are deployed at the network device side, the network device may configure reporting configuration information for the multiple AI models respectively, wherein a configuration method for each AI model is identical to the configuration method for deploying the one AI model described above, or common reporting configuration information may be configured for multiple AI models, which shall not be described herein any further.

In some embodiments, after configuring the measurement resource configuration information and the reporting configuration information, the network device may transmit to the terminal equipment a reference signal set to be measured (reference signals configured in the measurement resource configuration information). The network device configures such information as time-frequency resources, and periods, etc., in the measurement resource configuration information, and transmits a corresponding reference signal set on a corresponding time-frequency resource, so that the terminal equipment performs beam measurement on received reference signals. In 302, according to the above reporting configuration information, the terminal equipment may determine to report measurement results to which beams (pairs) correspond, that is, measurement results of designated beams (pairs) are reported according to configuration of the network device. Wherein, the measurement report reported by the terminal equipment includes measurement results to which first reference signals in a first reference signal set specified by the network device correspond, and/or measurement results to which first receiving beams in the first receiving beam set correspond, and/or measurement results to which first transceiving beam pairs in the first transceiving beam set correspond. The measurement report is carried by UCI. The measurement result is used for beam management based on the AI model (e.g. for data collection, or inference, or monitoring, of the AI model), which shall be described below respectively.

In some embodiments, the measurement report includes measurement results to which each first reference signal in the first reference signal set corresponds.

For example, when the measurement report is used for data collection for training the AI model, the network device configures the first reference signal set for the terminal equipment. When measurement results of all downlink transmitting beam need to be collected, the network device configures a corresponding first reference signal set for all the downlink transmitting beams in the reporting configuration information, and the terminal equipment reports measurement results of all the downlink transmitting beams (first reference signal set). When measurement results of only a part of the downlink transmitting beams need to be collected, the network device configures a corresponding first reference signal set for a part of the downlink transmitting beams it needs in the reporting configuration information, and the terminal equipment reports measurement results of the part of the downlink transmitting beams (first reference signal set) designated by it.

For example, when the measurement report is used for AI model inference, the network device configures a corresponding first reference signal set for a part of the downlink transmitting beams it needs in the reporting configuration information, and the terminal equipment reports measurement results of the part of the downlink transmitting beams (first reference signal set) designated by it.

For example, when the measurement report is used for AI model performance monitoring, the network device configures a corresponding first reference signal set for a part of the downlink transmitting beams needed in the AI model inference in the reporting configuration information, and the terminal equipment reports measurement results of the part of the downlink transmitting beams (first reference signal set) designated by it.

When there are multiple AI models with identical functions that need performance monitoring, the network device may configure multiple instances of reporting configuration for the multiple AI models, each instance of reporting configuration being configured with a reference signal to which a part of downlink transmitting beam configurations needed in the AI model inference correspond. The terminal equipment reports measurement results of the part of the downlink transmitting beams (first reference signal set) designated by it. Or, the network device may configure an instance of a reporting configuration for multiple AI models, the instance being configured with a first reference signal set to which common downlink transmitting beams needed in inference of multiple AI models correspond, and the terminal equipment reports measurement results of all or a part of downlink transmitting beams (first reference signal set) designated by it. The network device selects from the measurement results of the terminal equipment according to the downlink transmitting beams needed in the inference of the AI models, so as to monitor performances of the AI models.

In some embodiments, the measurement report includes measurement results to which each first receiving beam in the first receiving beam set corresponds.

For example, when the measurement report is used for data collection for training AI models, the network device configures a first receiving beam set for the terminal equipment. When measurement results of all downlink receiving beams need to be collected, the network device configures a corresponding first receiving beam set for all the downlink receiving beams in the reporting configuration information, and the terminal equipment reports measurement results of all the downlink receiving beams (first receiving beam set). When measurement results of only a part of downlink receiving beams need to be collected, the network device configures a corresponding first receiving beam set for the part of the downlink receiving beams it needs in the reporting configuration information, and the terminal equipment reports measurement results of the part of the downlink receiving beams (first receiving beam set) designated by it.

For example, when the measurement report is used for AI model inference, the network device configures a first receiving beam set to which a part of downlink receiving beams needed in the AI model inference correspond in the reporting configuration information, and the terminal equipment reports measurement results of the part of the downlink receiving beams (first receiving beam set) designated by it.

For example, when the measurement report is used for AI model performance monitoring, the network device configures a first receiving beam set to which a part of downlink receiving beams needed in the AI model inference correspond in the reporting configuration information, and the terminal equipment reports measurement results of the part of the downlink receiving beams (first receiving beam set) designated by it.

When there are multiple AI models with identical functions that need performance monitoring, the network device may configure multiple instances of reporting configuration for the multiple AI models, each instance of reporting configuration being configured with a first receiving beam set to which a part of downlink receiving beam configuration needed in the AI model inference corresponds, and the terminal equipment reports measurement results of the part of the downlink receiving beams (first receiving beam set) designated by it. Or, the network device may configure an instance of reporting configuration for the multiple AI models, the instance being configured with a first receiving beam set to which common downlink receiving beams needed in the AI model inference correspond, and the terminal equipment reports measurement results of all or the part of the downlink receiving beams (first receiving beam set) designated by it. The network device selects from the measurement results of the terminal equipment according to the downlink receiving beams needed in the inference of the AI models, so as to monitor performances of the AI models.

In some embodiments, the measurement report includes measurement results to which each first transceiving beam pair in the first transceiving beam pair set corresponds.

For example, when the measurement report is used for data collection for AI model training, the network device configures a first transceiving beam pair set for the terminal equipment. When measurement results of all downlink transceiving beam pairs need to be collected, the network device configures a corresponding first transceiving beam pair set for all the downlink transceiving beam pairs in the reporting configuration information, and the terminal equipment reports measurement results of all the downlink transceiving beam pairs (first transceiving beam pair set). And when measurement results of only a part of the downlink transceiving beam pairs need to be collected, the network device configures a corresponding first transceiving beam pair set for the part of downlink transceiving beam pairs it needs in the reporting configuration information, and the terminal equipment reports measurement results of the part of the downlink transceiving beam pairs (first transceiving beam pair set) designated by it.

For example, when the measurement report is used for AI model inference, the network device configures a corresponding first downlink transceiving beam pair set needed in the AI model inference in the reporting configuration information, and the terminal equipment reports measurement results of the part of the downlink transceiving beam pairs (first transceiving beam pair set) designated by it.

For example, when the measurement report is used for AI model performance monitoring, the network device configures a corresponding first transceiving beam pair set needed in the AI model inference in the reporting configuration information, and the terminal equipment reports measurement results of the part of the downlink transceiving beam pairs (first transceiving beam pair set) designated by it.

When there are multiple AI models with identical functions that need performance monitoring, the network device may configure multiple instances of reporting configuration for the multiple AI models, each instance of reporting configuration being configured with a first transceiving beam pair set to which a part of downlink transceiving beam pair configuration needed in the AI model inference corresponds, and the terminal equipment reports measurement results of the part of the downlink transceiving beam pairs (first transceiving beam pair set) designated by it. Or, the network device may configure an instance of reporting configuration for the multiple AI models, the instance being configured with a first transceiving beam pair set to which common downlink transceiving beam pairs needed in the inference of the multiple AI models correspond, and the terminal equipment reports measurement results of all or the part of the downlink transceiving beam pairs (first transceiving beam pair set) designated by it. The network device selects from the measurement results of the terminal equipment according to the downlink transceiving beam pairs needed in the inference of the AI models, so as to monitor performances of the AI models.

The embodiments of this disclosure are exemplified above. However, this disclosure is not limited thereto, and appropriate variants may be made on the basis of these embodiments. For example, the above embodiments may be executed separately, or one or more of them may be executed in a combined manner.

With the above embodiments, by configuring information on the first transmitting beam (corresponding to the first reference signal) or the first receiving beam or the first transceiving beam pair for the terminal equipment that needs to be reported by the terminal equipment, the terminal equipment reports the beam measurement results specified by the network device according to the configuration, thereby effectively enabling the AI model to operate in the inference stage, data collection stage for training, or model performance monitoring stage.

### Embodiments of a Second Aspect

The embodiments of this disclosure provide an information transceiving method, which shall be described from a terminal equipment side, with contents identical to those in the embodiments of the first aspect being not going to be described herein any further. An AI model is deployed at a network device side.

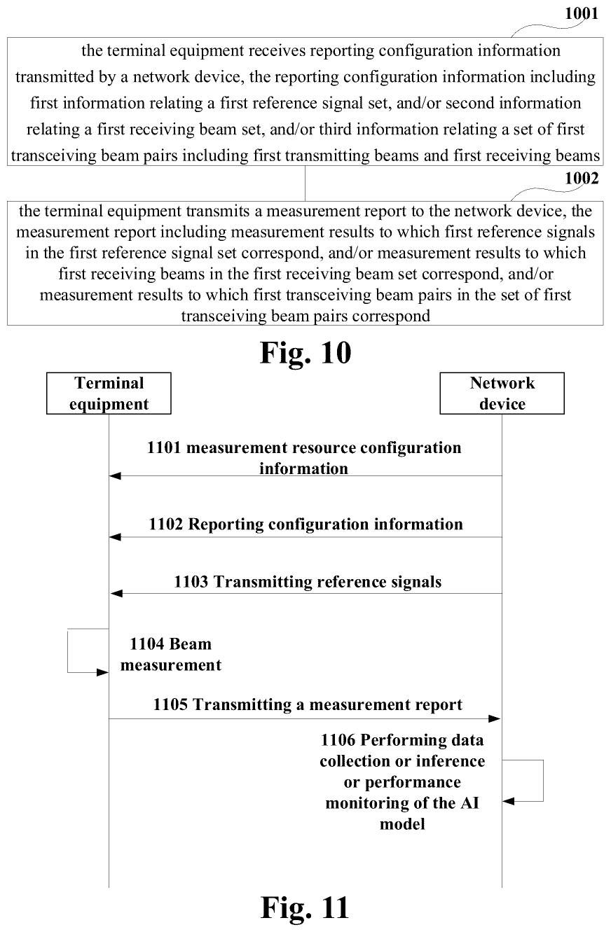

FIG. 10 is a schematic diagram of the information transceiving method of the embodiments of this disclosure. As shown in FIG. 10, the method includes:
1001: the terminal equipment receives reporting configuration information transmitted by a network device, the reporting configuration information including first information relating a first reference signal set, and/or second information relating a first receiving beam set, and/or third information relating a set of first transceiving beam pairs including first transmitting beams and first receiving beams; and
1002: the terminal equipment transmits a measurement report to the network device, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

It should be noted that FIG. 10 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 10.

In some embodiments, implementations of 1001-1002 correspond to those of 301-302, and reference may be made to the embodiments of the first aspect for implementations of the reporting configuration information and the measurement report, which shall not be described herein any further.

The embodiments of this disclosure are exemplified above. However, this disclosure is not limited thereto, and appropriate variants may be made on the basis of these embodiments. For example, the above embodiments may be executed separately, or one or more of them may be executed in a combined manner.

With the above embodiments, by configuring information on the first transmitting beam (corresponding to the first reference signal) or the first receiving beam or the first transceiving beam pair for the terminal equipment that needs to be reported by the terminal equipment, the terminal equipment reports the beam measurement results specified by the network device according to the configuration, thereby effectively enabling the AI model to operate in the inference stage, data collection stage for training, or model performance monitoring stage.

A method for transceiving information between the terminal equipment and the network device in the embodiments of the first aspect and the embodiments of the second aspect shall be described below.

FIG. 11 is a schematic diagram of the information transceiving method of the embodiments of this disclosure. As shown in FIG. 11, the method includes:
1101: the network device transmits measurement resource configuration information to the terminal equipment;
1102: the network device transmits reporting configuration information to the terminal equipment, the reporting configuration information including first information relating a first reference signal set, and/or second information relating a first receiving beam set, and/or third information relating a set of first transceiving beam pairs including first transmitting beams and first receiving beams;
1103: the network device transmits reference signals in a reference signal set to the terminal equipment;
1104: the terminal equipment performs beam measurement by using the reference signals, for example, the measuring RSRP or SINR of downlink transmitting beams, or downlink receiving beams, or downlink transceiving beams, based on the reference signals;
1105: the terminal equipment transmits a measurement report to the network device, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond; and
1106: the network device performs data collection or inference or performance monitoring of the AI model by using the measurement results in the measurement report.

Implementations of 1101-1106 are as described above, and shall not be repeated herein any further.

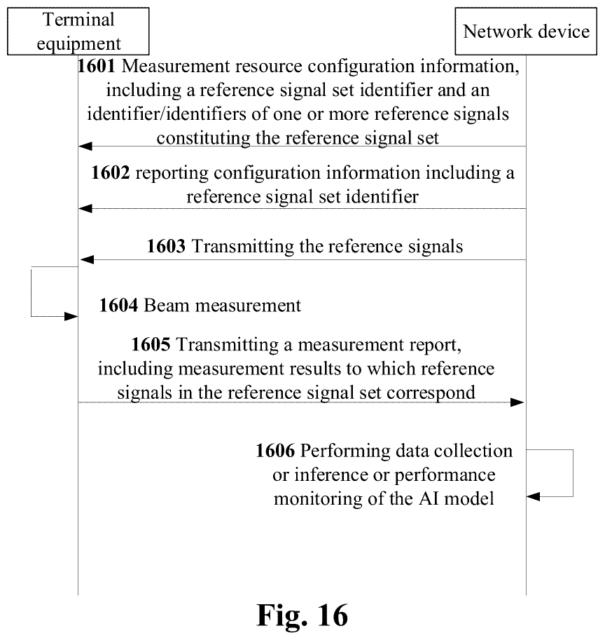

FIG. 16 is a schematic diagram of the information transceiving method of the embodiments of this disclosure. As shown in FIG. 16, the method includes:
1601: the network device transmits measurement resource configuration information to the terminal equipment, the measurement resource configuration information including a reference signal set identifier and an identifier/identifiers of one or more reference signals constituting the reference signal set;
1602: the network device transmits the reporting configuration information to the terminal equipment, the reporting configuration information including the identifier(s) of the reference signal(s);
1605: the network device receives a measurement report transmitted by the terminal equipment, the measurement report including measurement results to which reference signals in the reference signal set correspond;

The method may further include:
1603: the network device transmits the reference signals in the reference signal set to the terminal equipment;
1604: the terminal equipment performs beam measurement by using the reference signals, such as measuring RSRP or SINR of downlink transmitting beams or downlink receiving beams or downlink transceiving beams based on the reference signals; and
1606: the network device performs data collection or inference or performance monitoring of the AI model by using the measurement results in the measurement report.

### Embodiments of a Third Aspect

The embodiments of this disclosure provide an information transceiving apparatus. The apparatus may be, for example, a terminal equipment, or one or some components or assemblies configured in the terminal equipment. Contents in the embodiments identical to those in the embodiments of the second aspect shall not be described herein any further.

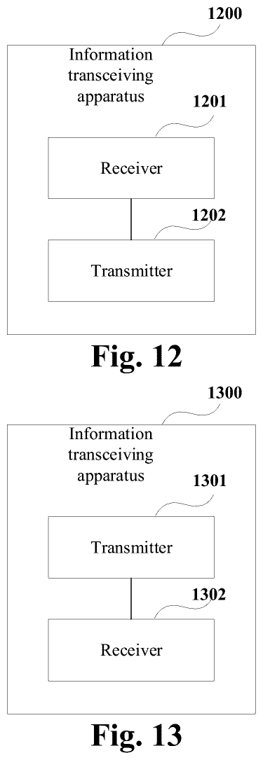

FIG. 12 is a schematic diagram of the information transceiving apparatus of the embodiments of this disclosure. As shown in FIG. 12, the information transceiving apparatus 1200 includes:
a receiver 1201 configured to receive reporting configuration information transmitted by a network device, the reporting configuration information including first information relating a first reference signal set, and/or second information relating a first receiving beam set, and/or third information relating a set of first transceiving beam pairs including first transmitting beams and first receiving beams; and
a transmitter 1202 configured to transmit a measurement report to the network device, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

In some embodiments, the first information includes an index of a first reference signal.

In some embodiments, the second information includes first receiving beam identification information or first receiving beam angle information.

In some embodiments, the third information includes the first information and the second information.

In some embodiments, the reporting configuration information is carried by RRC or MAC CE or DCI.

In some embodiments, the first reference signal corresponds to the first transmitting beam.

In some embodiments, an AI model is deployed at the network device.

In some embodiments, the measurement report is used for data collection or inference or monitoring of the AI model.

In some embodiments, the measurement report is carried by UCI.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1200 may further include other components or modules, and reference may be made to related techniques for particulars of these components or modules.

Furthermore, for the sake of simplicity, connection relationships between the components or modules or signal profiles thereof are only illustrated in FIG. 12. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Fourth Aspect

The embodiments of this disclosure provide an information transceiving apparatus. The apparatus may be, for example, a network device, or one or some components or assemblies configured in the network device. Contents in the embodiments identical to those in the embodiments of the first aspect shall not be described herein any further.

FIG. 13 is a schematic diagram of the information transceiving apparatus of the embodiments of this disclosure. As shown in FIG. 13, the information transceiving apparatus 1300 includes:
a transmitter 1301 configured to transmit reporting configuration information to a terminal equipment, the reporting configuration information including first information of a first reference signal set, and/or second information of a first receiving beam set, and/or third information of a set of first transceiving beam pairs including first transmitting beams and first receiving beams; and
a receiver 1302 configured to receive a measurement report transmitted by the terminal equipment, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

In some embodiments, the first information includes an index of a first reference signal.

In some embodiments, the second information includes first receiving beam identification information or first receiving beam angle information.

In some embodiments, the third information includes the first information and the second information.

In some embodiments, the reporting configuration information is carried by RRC or MAC CE or DCI.

In some embodiments, the first reference signal corresponds to the first transmitting beam.

In some embodiments, an AI model is deployed at the network device.

In some embodiments, the apparatus further includes:
a processor (not shown) configured to perform data collection or inference or monitoring of the AI model according to the measurement report.

In some embodiments, the measurement report is carried by UCI.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1300 may further include other components or modules, and reference may be made to related techniques for particulars of these components or modules.

Furthermore, for the sake of simplicity, connection relationships between the components or modules or signal profiles thereof are only illustrated in FIG. 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include a network device 101 and/or a terminal equipment 102, wherein the network device 101 includes the information transceiving apparatus 1300 described in the embodiments of the fourth aspect, and the terminal equipment includes the information transceiving apparatus 1200 described in the embodiments of the third aspect, which shall not be described herein any further.

The embodiments of this disclosure further provide a network device, which may be, for example, a base station. However, this disclosure is not limited thereto, and it may also be another network device.

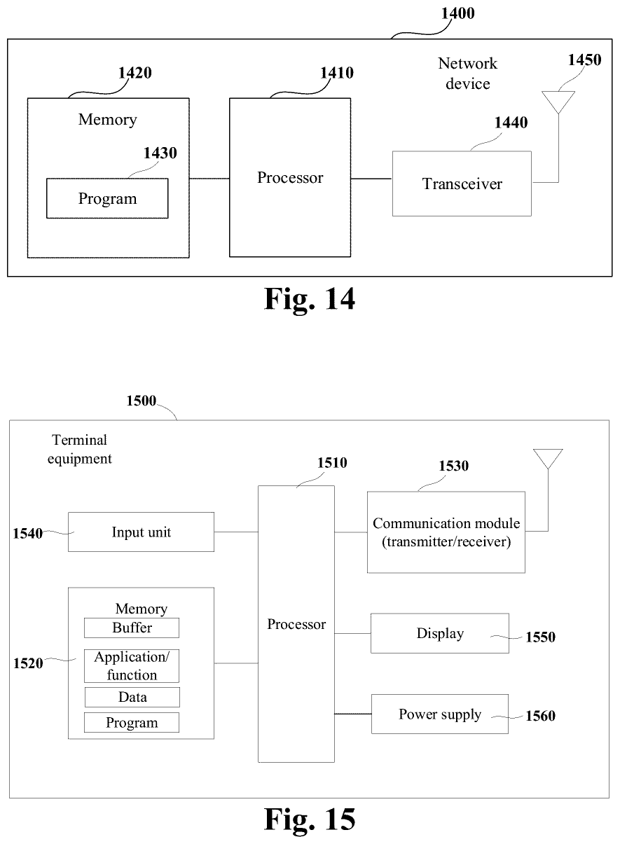

FIG. 14 is a schematic diagram of a structure of the network device of the embodiments of this disclosure. As shown in FIG. 14, the network device 1400 may include a processor 1410 (such as a central processing unit (CPU)) and a memory 1420, the memory 1420 being coupled to the processor 1410. Wherein, the memory 1420 may store various data, and furthermore, it may store a program 1430 for information processing, and execute the program 1430 under control of the processor 1410.

For example, the processor 1410 may be configured to execute a program to carry out the information transceiving method described in the embodiments of the first aspect.

Furthermore, as shown in FIG. 14, the network device 1400 may include a transceiver 1440, and an antenna 1450, etc. Wherein, functions of the above components are similar to those in the related art, and shall not be described herein any further. It should be noted that the network device 1400 does not necessarily include all the parts shown in FIG. 14, and furthermore, the network device 1400 may include parts not shown in FIG. 14, and the related art may be referred to.

The embodiments of this disclosure further provide a terminal equipment; however, this disclosure is not limited thereto, and it may also be another equipment.

FIG. 15 is a schematic diagram of the terminal equipment of the embodiments of this disclosure. As shown in FIG. 15, the terminal equipment 1500 may include a processor 1510 and a memory 1520, the memory 1520 storing data and a program and being coupled to the processor 1510. It should be noted that this figure is illustrative only, and other types of structures may also be used, so as to supplement or replace this structure and achieve a telecommunications function or other functions.

For example, the processor 1510 may be configured to execute a program to carry out the information transceiving method as described in the embodiments of the second aspect.

As shown in FIG. 15, the terminal equipment 1500 may further include a communication module 1530, an input unit 1540, a display 1550, and a power supply 1560; wherein functions of the above components are similar to those in the related art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the related art may be referred to.

Embodiments of this disclosure provide a computer program, which, when executed in a terminal equipment, will cause the terminal equipment to carry out the information transceiving method as described in the embodiments of the second aspect.

Embodiments of this disclosure provide a computer storage medium, including a computer program, which will cause a terminal equipment to carry out the information transceiving method as described in the embodiments of the second aspect.

Embodiments of this disclosure provide a computer program, which, when executed in a network device, will cause the network device to carry out the information transceiving method as described in the embodiments of the first aspect.

Embodiments of this disclosure provide a computer storage medium, including a computer program, which will cause a network device to carry out the information transceiving method as described in the embodiments of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information transceiving method, applicable to a network device, characterized in that the method includes:
transmitting reporting configuration information by the network device to a terminal equipment, the reporting configuration information including first information relating a first reference signal set, and/or second information relating a first receiving beam set, and/or third information relating a set of first transceiving beam pairs including first transmitting beams and first receiving beams; and
receiving, by the network device, a measurement report transmitted by the terminal equipment, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

2. The method according to supplement 1, wherein the first information includes an index of a first reference signal.

3. The method according to supplement 1, wherein the second information includes first receiving beam identification information or first receiving beam angle information.

4. The method according to supplement 1, wherein the third information includes the first information and the second information.

5. The method according to supplement 1, wherein the reporting configuration information is carried by RRC or MAC CE or DCI.

6. The method according to supplement 1, wherein the first reference signal corresponds to the first transmitting beam.

7. The method according to supplement 1, wherein an AI model is deployed at the network device.

8. The method according to supplement 7, wherein the method further includes:
performing data collection or inference or monitoring of the AI model by the network device according to the measurement report.

9. The method according to supplement 1, wherein the measurement report is carried by UCI.

10. An information transceiving method, applicable to a terminal equipment, characterized in that the method includes:
receiving, by the terminal equipment, reporting configuration information transmitted by a network device, the reporting configuration information including first information relating a first reference signal set, and/or second information relating a first receiving beam set, and/or third information relating a set of first transceiving beam pairs including first transmitting beams and first receiving beams; and transmitting a measurement report by the terminal equipment to the network device, the measurement report including measurement results to which first reference signals in the first reference signal set correspond, and/or measurement results to which first receiving beams in the first receiving beam set correspond, and/or measurement results to which first transceiving beam pairs in the set of first transceiving beam pairs correspond.

11. The method according to supplement 10, wherein the first information includes an index of a first reference signal.

12. The method according to supplement 10, wherein the second information includes first receiving beam identification information or first receiving beam angle information.

13. The method according to supplement 10, wherein the third information includes the first information and the second information.

14. The method according to supplement 10, wherein the reporting configuration information is carried by RRC or MAC CE or DCI.

15. The method according to supplement 10, wherein the first reference signal corresponds to the first transmitting beam.

16. The method according to supplement 10, wherein an AI model is deployed at the network device.

17. The method according to supplement 16, wherein the measurement report is used for data collection or inference or monitoring of the AI model.

18. The method according to supplement 10, wherein the measurement report is carried by UCI.

19. An information transceiving method, applicable to a network device, characterized in that the method includes:
transmitting measurement resource configuration information by the network device to a terminal equipment, the measurement resource configuration information including a reference signal set identifier and an identifier/identifiers of one or more reference signals constituting the reference signal set;
transmitting reporting configuration information by the network device to the terminal equipment, the reporting configuration information including the reference signal set identifier; and
receiving, by the network device, a measurement report transmitted by the terminal equipment, the measurement report including measurement results to which reference signals in the reference signal set correspond.

20. An information transceiving method, applicable to a terminal equipment, characterized in that the method includes:
receiving, by the terminal equipment, measurement resource configuration information transmitted by a network device, the measurement resource configuration information including a reference signal set identifier and an identifier/identifiers of one or more reference signals constituting the reference signal set;
receiving, by the terminal equipment, reporting configuration information transmitted by the network device, the reporting configuration information including the identifier(s) of the reference signal(s); and
transmitting a measurement report by the terminal equipment to the network device, the measurement report including measurement results to which reference signals in the reference signal set correspond;

21. A network device, including a memory and a processor, the memory storing a computer program, and the processor being configured to execute the computer program to carry out the method as described in any one of supplements 1-9 and 19.

22. A terminal equipment, including a memory and a processor, the memory storing a computer program, and the processor being configured to execute the computer program to carry out the method as described in any one of supplements 10-18 and 20.

1. An information transceiving apparatus, applicable to a network device, the apparatus comprising:
a transmitter configured to transmit reporting configuration information to a terminal equipment, the reporting configuration information comprising first information relating a first reference signal set, and/or second information relating a first receiving beam set, and/or third information relating a set of first transceiving beam pairs comprising first transmitting beams and first receiving beams; and
a receiver configured to receive a measurement report transmitted by the terminal equipment, the measurement report comprising measurement results to which first reference signals in the first reference signal set correspond, and/or measurement results to which first receiving beams in the first receiving beam set correspond, and/or measurement results to which first transceiving beam pairs in the set of first transceiving beam pairs correspond.

2. The apparatus according to claim 1, wherein the first information comprises an index of a first reference signal.

3. The apparatus according to claim 1, wherein the second information comprises first receiving beam identification information or first receiving beam angle information.

4. The apparatus according to claim 1, wherein the third information comprises the first information and the second information.

5. The apparatus according to claim 1, wherein the reporting configuration information is carried by RRC or MAC CE or DCI.

6. The apparatus according to claim 1, wherein the first reference signal corresponds to the first transmitting beam.

7. The apparatus according to claim 1, wherein an AI model is deployed at the network device.

8. The apparatus according to claim 7, the apparatus further comprising:
processor circuitry configured to perform data collection or inference or monitoring of the AI model according to the measurement report.

9. The apparatus according to claim 1, wherein the measurement report is carried by UCI.

10. An information transceiving apparatus, applicable to a terminal equipment, the apparatus comprising:
a receiver configured to receive reporting configuration information transmitted by a network device, the reporting configuration information comprising first information of a first reference signal set, and/or second information of a first receiving beam set, and/or third information of a set of first transceiving beam pairs comprising first transmitting beams and first receiving beams; and
a transmitter configured to transmit a measurement report to the network device, the measurement report comprising measurement results to which first reference signals in the first reference signal set correspond, and/or measurement results to which first receiving beams in the first receiving beam set correspond, and/or measurement results to which first transceiving beam pairs in the set of first transceiving beam pairs correspond.

11. The apparatus according to claim 10, wherein the first information comprises an index of a first reference signal.

12. The apparatus according to claim 10, wherein the second information comprises first receiving beam identification information or first receiving beam angle information.

13. The apparatus according to claim 10, wherein the third information comprises the first information and the second information.

14. The apparatus according to claim 10, wherein the reporting configuration information is carried by RRC or MAC CE or DCI.

15. The apparatus according to claim 10, wherein the first reference signal corresponds to the first transmitting beam.

16. The apparatus according to claim 10, wherein an AI model is deployed at the network device.

17. The apparatus according to claim 16, wherein the measurement report is used for data collection or inference or monitoring of the AI model.

18. The apparatus according to claim 10, wherein the measurement report is carried by UCI.

19. A communication system, comprising a network device and a terminal equipment;
wherein the network device is configured to transmit reporting configuration information, the reporting configuration information comprising first information relating a first reference signal set, and/or second information relating a first receiving beam set, and/or third information relating a set of first transceiving beam pairs comprising first transmitting beams and first receiving beams, and receive a measurement report, the measurement report comprising measurement results to which first reference signals in the first reference signal set correspond, and/or measurement results to which first receiving beams in the first receiving beam set correspond, and/or measurement results to which first transceiving beam pairs in the set of first transceiving beam pairs correspond; and
wherein the terminal equipment is configured to receive the reporting configuration information, and transmit the measurement report.

20. The communication system according to claim 19, wherein the first information comprises an index of a first reference signal, or the second information comprises first receiving beam identification information or first receiving beam angle information, or the third information comprises the first information and the second information.
